(19) United States
(12) Patent Application Publication
(10) Pub. No.: US 2013/0192744 A1
(43) Pub. Date: Aug. 1, 2013

(54) Oriented Impact Copolymer Polypropylene Film

(71) Applicant: Avery Dennison Corporation, Pasadena, CA (US)

(72) Inventor: Kevin O. HENDERSON, Willoughby Hills, OH (US)

(73) Assignee: AVERY DENNISON CORPORATION, Pasadena, CA (US)

(21) Appl. No.: 13/755,255

(22) Filed: Jan. 31, 2013

Related U.S. Application Data
(60) Provisional application No. 61/592,659, filed on Jan. 31, 2012.

(51) Int. Cl. C08L 23/12; B32B 27/08

(52) U.S. Cl. CPC C08L 23/12; B32B 27/08
USPC 156/84; 428/516; 428/518; 428/523; 428/343; 428/354; 156/60; 525/222; 525/240

(57) ABSTRACT

Label facestock and label assemblies utilizing the facestock are described. The label facestock includes impact copolymer polypropylene (ICP). The label facestock is also axially oriented.

### CROSS REFERENCE TO RELATED APPLICATION

The present application claims the benefit of U.S. Provisional Application No. 61/592,659 filed Jan. 31, 2012, which is incorporated herein in its entirety.

### FIELD

The present subject matter relates to polypropylene based films, and labels prepared from such films. More particularly, the subject matter relates to polypropylene based compositions comprising an impact propylene polymer, and films and labels prepared therefrom that are ink printable, die-cuttable and/or scuff resistant.

### BACKGROUND

It has long been known to manufacture and distribute pressure sensitive adhesive stock for labels by providing a layer of facestock material and a layer of pressure sensitive adhesive which in turn is covered by a release liner or carrier. The liner or carrier protects the adhesive during shipment and storage and allows for efficient handling of an array of individual labels after the labels are die-cut and the waste is stripped from the layer of facestock material up to the point where the individual labels are dispensed in sequence on a labeling line. A typical method of die cutting uses a steel die blade. During the time from die-cutting to dispensing, the liner or carrier remains uncut and may be rolled and unrolled for storage, transit and deployment of the array of individual labels carried thereon.

In many label applications, it is desirable that the facestock material be a film of polymeric material which can provide properties lacking in paper, such as clarity, durability, strength, water-resistance, abrasion-resistance, gloss and other properties. Historically, polymeric facestock material of thicknesses greater than about 3 mils (75 microns) have been used in order to assure dispensability in automatic labeling equipment. For example, plasticized polyvinyl chloride films about 3.5 to 4.0 mils (87.5 to 100 microns) thick were used in label application because these films exhibited the desired flexibility characteristics. However, the migration of the plasticizers used in PVC films to convert the normally rigid films to flexible films was recognized as a major problem for these types of films resulting in loss of desirable properties such as adhesion and flexibility, as well as other problems such as ink anchorage failure, color buildup, and shrinkage. Eventually, migration of the plasticizer results in wrinkling, cracking and visual deterioration of the facestock and/or label. Also, it is desirable to reduce the thickness or “down-gauge” the facestock material in order to attain savings in material costs. Such reduction in facestock thickness often has resulted in reduced stiffness and the inability to die-cut and dispense the labels in a reliable and commercially acceptable manner using automatic machinery. In addition, environmental reasons exist for preparing labels from facestock polymers other than polyvinyl chloride.

Polymeric materials suggested in the prior art as useful in preparing labels include biaxially-oriented polypropylene (“BOPP”) of thicknesses as low as about 2.0 mils (50 microns). These materials provide cost savings as they are relatively inexpensive, and they have sufficient stiffness to dispense well. However, these materials also have relatively high tensile modulus values in both machine direction (MD) and cross direction (CD) which results in unacceptable conformability characteristics. When biaxially-oriented films are applied to rigid substrates such as glass bottles, the application is not completely successful. The relatively stiff labels have a tendency to bridge surface depressions and the mold seams resulting from bottle forming processes result in an undesirable surface appearance of the applied label simulating trapped air bubbles. This has somewhat impeded the use of pressure sensitive adhesive labels to replace prior glass bottle labeling techniques such as ceramic ink directly bonded to the bottle surface during glass bottle manufacturing processes as customers find the appearance unattractive. Such ceramic ink techniques are environmentally undesirable due to objectionable ink components which contaminate crushed bottle glass in recycling processes. Attempts to use the relatively stiff oriented polypropylene films on flexible substrates such as plastic bottles also have not been completely successful because the labels do not have the flexibility required to conform to the flexible plastic containers. Oriented polypropylene films are also more difficult to print than PVC or polyethylene films.

Other useful materials include unoriented polyethylene and polypropylene films that are also relatively inexpensive and conformable. However, both of these films are difficult to die-cut and do not dispense well at low calipers. In Europe, an unoriented, relatively thick polyethylene facestock has been used successfully in preparing labels. The facestock is die-cuttable and the labels can be dispensed in high speed automatic dispensing equipment. The normal thickness of this “standard” polyethylene facestock in Europe is about 4.0 mils (100 microns). Attempts to reduce the gauge of the polyethylene facestock to reduce costs has not yet met with sign f cant success because the thinner polyethylene facestock is not readily die-cuttable with the die leaving a mark on the liner, stringers on the cut label, and/or hangers between the labels. A stringer (also called ticker) is a small thread of material between the label and the matrix after die cutting. Thus, the label and matrix are still connected by a small string of material. A stringer occurs when the label is not clean cut, and it can cause the label to be removed with the waste label material. A hanger occurs when a segment of the CD label material breaks during CD stripping. Additionally, the thinner facestock becomes difficult to dispense at higher speeds over a peel plate because of reduced stiffness.

In addition, many previously known polypropylene labels, particularly those including blends of ethylene vinyl acetate (EVA) and polypropylene, tend to produce relatively copious amounts of dust or polymeric residue. This is undesirable because periodic cleaning of associated equipment is then required. It is believed that such dust results from the relatively poor resistance these materials exhibit against scuffing or other contact with equipment and materials.

Since labels are intended to carry information, the printability of filmic pressure sensitive adhesive labels is very important. Printability is defined by the sharpness and brightness of the image and by the ink anchorage. The sharpness is closely related to the surface tension of the print surface. The ink anchorage is often tested by a tape test (F at test: FTM21). In general, PVC is printable with a variety of inks intended to be used with PVC. For polyolefin films, the inks are waterbased (especially in the US) or designed for UV drying (especially in Europe). In general, all polyolefin films can be printed with UV inks after on-press corona treatment, polyethylene (PE) being better than polypropylene (PP) mainly on ink adhesion. For waterbased inks an additional primer or topcoat is needed to achieve good ink anchorage.

In view of these concerns and problems, a need exists for an improved film material that exhibits good printability properties, is readily die-cuttable, and avoids prior art problems of dust formation and poor scuff resistance.

### SUMMARY

The difficulties and drawbacks associated with previously known labels and systems are addressed in the present films, labels, and related methods.

In one aspect, the subject matter provides an axially oriented label facestock comprising a blend of an impact copolymer polypropylene (ICP) and at least one other polymeric material.

In another aspect, the subject matter provides a label assembly comprising a substrate and a layer of an adhesive. The substrate is axially oriented and includes a blend of an impact copolymer polypropylene (ICP) and at least one other polymeric material.

In still another aspect, the subject matter provides a method of labeling. The method comprises providing a label assembly that includes (i) an axially oriented substrate including a blend of an impact copolymer polypropylene (ICP) and at least one other polymeric material, and (ii) a layer of an adhesive. The method also comprises contacting the layer of the adhesive with a container or other surface of interest.

In certain embodiments, the polymeric material is selected from homopolymer polypropylene (HPP), random copolymer polypropylene (RCP), and combinations thereof.

As will be realized, the subject matter is capable of other and different embodiments and its several details are capable of modifications in various respects, all without departing from the subject matter. Accordingly, the drawings and description are to be regarded as illustrative and not restrictive.

### BRIEF DESCRIPTION OF THE DRAWINGS

FIG. 1 is a graph of die cut friction energies for various samples evaluated.

FIG. 2 is a graph of haze comparisons for various samples evaluated.

FIG. 3 is a graph of clarity comparisons for various samples evaluated.

FIG. 4 is a graph of gloss comparisons for various samples evaluated.

FIG. 5 is a graph of stiffness comparisons for various samples evaluated.

FIG. 6 is a graph of modulus comparisons for various samples evaluated.

FIG. 7 is a graph of density comparisons for various samples evaluated.

FIG. 8 is a graph of calculated die cut resistance for various samples evaluated.

FIG. 9 is a graph of calculated conformability for various samples evaluated.

FIG. 10 is a graph of measured haze for various samples evaluated.

FIG. 11 is a graph of calculated effect of increasing machine direction orientation on die cutting for various samples evaluated.

FIG. 12 is a graph of calculated effect of increasing machine direction orientation on conformability for various samples evaluated.

FIG. 13 is a graph of calculated die cut resistance for various samples evaluated.

FIG. 14 is a graph of calculated conformability for various samples evaluated.

### DETAILED DESCRIPTION OF THE EMBODIMENTS

Oriented impact copolymer polypropylene (ICP) film compositions and constructions are described. Preferably, the oriented films are mono-axially oriented or biaxially oriented. One application of the mono-axially oriented impact copolymer polypropylene film compositions is for use in adhesive label constructions. Other possible uses include, but are not limited to, in-mold labeling, tamper evident seals, and retort packaging.

In certain embodiments, impact copolymer polypropylene (ICP) is blended with homopolymer polypropylene (HPP) and/or random copolymer polypropylene (RCP). The addition of the ICP decreases the amount of temperature and stretch required to fully orient the HPP and the RCP. This creates a film with good stiffness and contact clarity. With the decrease in orientation temperature, it is now achievable to create a coextrusion with polyethylene (PE), without sticking to the rolls in a Machine Direction Orienter (MDO). The use of the ICP in blends allows for exterior skins based primarily on PE. Furthermore, in accordance with the present subject matter, it was discovered that adding a low percentage of alpha-olefin copolymer to PE, eliminates or at least significantly reduces the occurrence of natural surface “tears” that otherwise occur during orientation.

Preferred embodiment facestocks and labels can include material blends having a wide range of ICP blended with one or more other components such as for example HPP and RCP. In certain applications it is preferred to use blends containing at least 10%, more preferably at least 25%, and more preferably at least 50% ICP. In other applications, it is preferred to use blends containing less than 50%, more preferably less than 25%, and more preferably less than 10% ICP. It will be appreciated that selectively adjusting the proportion of ICP in a material layer enables one to readily modify the die cut resistance, conformability, and/or haze of the resulting material layer.

The preferred embodiment mono-axially oriented impact copolymer polypropylene film compositions comprise a heterophase propylene copolymer which is mono-axially oriented. The films may be coextruded with one or more adhesive layer(s), print layer(s) and/or other top layer(s), and the coextrudate stretched to provide the mono-axial orientation. The heterophase propylene copolymer provides good die cutting and the orientation provides good stiffness. These features are obtained while avoiding the problem of dusting which has occurred with currently used materials that include a blend of ethylene vinyl acetate (EVA) and polypropylene. Surprisingly, the heterophase propylene copolymer provides good die-cuttability even though it has improved impact properties which are normally associated with increased toughness, which in turn might be expected to lead to a decrease in die-cuttability.

Heterophase polypropylene is also referred to as impact polypropylene or impact-modified polypropylene, and may also be referred to as polypropylene block copolymer. Heterophasic propylene copolymers incorporate rubbery properties to the normally rigid backbone of polypropylene. These copolymers are produced in a reaction by sequential copolymerization of propylene with elastomers such as ethylene-propylene rubber (EPR) and ethylene-propylene-diene monomer rubber (EPDM rubber). The copolymers can be tailored for specific applications resulting from the flexibility in the selection of feedstocks, fillers, and additives, as well as the polymerization sequences and conditions. The copolymers generally contain from about 8 to about 20% elastomer, although this may vary. The addition of the elastomeric, rubbery material to the polypropylene matrix increases the resiliency of the materials obtained and makes them useful in applications where good impact resistance at low temperature is needed. In the past, heterophase propylene copolymers have been widely used in automobile manufacturing. These materials are collectively referred to herein as impact copolymer polypropylene (ICP).

Heterophase propylene copolymers are available in high, medium, and low impact versions. Generally, impact properties may be measured by ASTM D256 in what is referred to as the Notched Izod Test at 23° C. Using this test, “high impact” is defined as no break, “medium impact” is defined as break at 3-4 ft-lb/in and “low impact” is defined as break at 1-2 ft-lb/in impact. Another method of determining high, medium, or low impact for heterophase propylene copolymers is by extraction of the rubbery component, for example the EPR component. On this basis, “high impact” is defined as an extractable EPR content greater than 16%, “medium impact” is 12-16% extractable EPR, and “low impact” is 8-12% extractable EPR. Finally, another method used by Dow for classifying as high, medium, or low impact depends on the ethylene content added to the polymerization reactor. By this definition, “high impact” is 15-20% ethylene, “medium impact” is 9-15% ethylene, and “low impact” is 5-9% ethylene. The importance of impact modification is in the resultant tensile properties. The single impact polypropylene resin can replace currently used blends of two or more resins. The benefits include reduced cost, improved die-cuttability, and reduced dust production during die cutting. Accumulation of dust results in line stoppages for cleaning.

It is contemplated that the ICP may be used either alone or blended with other polymers, such as polyethylenes, polypropylenes, other polyolefins, (meth)acrylates, ethylene vinyl acetate copolymers, ionomers, and a variety of other polymers and copolymers in forming the film compositions. A wide array of polyethylenes can be used such as low density polyethylene, linear low density polyethylene, and metallocene-catalyzed linear low density polyethylene. A wide array of polypropylenes can be used such as homopolymer polypropylene, and random copolymer polypropylene. It is also contemplated that copolymers of ethylene and propylene can be used such as for example alpha-olefin ethylene/propylene copolymer. Various ionomers can be used such as zinc ionomers. It will be appreciated that in no way is the subject matter limited to any of these particular materials or combinations of materials. Instead, it is contemplated that a wide array of other materials can be utilized.

Other additives that may be present in these compositions include nucleating agents, antioxidants, and processing aids. The nucleating agent, used to add stiffness, may be a sorbitol type or an organic phosphite, present up to about 2,000 ppm. The antioxidants may be a combination of phenolics and phosphates, present from about 800 to about 1,500 ppm each. The processing aid may be calcium stearate, present from about 300 to about 700 ppm, with the lower amounts preferred. Similarly, it will be understood that the subject matter includes the use of other additives and agents.

Preferably, films comprising ICP are relatively thin and have a thickness less than about 3 mils. It will however be appreciated that the subject matter includes films that have thicknesses greater than 3 mils.

The preferred embodiment films and label assemblies exhibit shrink characteristics. Preferably, the film(s) are axially oriented films and most preferably monoaxially oriented or bi-axially oriented. In many of the preferred embodiments described herein, the oriented films are mono-axially oriented. Methods for orienting and/or forming shrink films are described in one or more of the following patents, all owned by the assignee of the present application: U.S. Pat. Nos. 7,700,189; 6,919,113; 6,808,822; 6,716,501; 6,436,496; 5,747,192; 5,242,650; and 5,190,609. Additional details of forming oriented films are provided in one or more of the following patents: U.S. Pat. Nos. 4,020,141; 4,059,667; 4,124,677; 4,399,181; 4,430,377; 4,551,380; 4,724,185; 4,797,235; 4,957,790; 5,089,352; 5,254,393; and 5,292,561.

The preferred embodiment films and label assemblies may also include one or more layers of adhesive. The adhesive is preferably a pressure sensitive adhesive. And, the preferred films and label assemblies may also include one or more liners or liner assemblies. Preferably, the liner or liner assembly includes a silicone material.

The present subject matter also includes various methods involving the preferred films and label assemblies. For example, methods of labeling containers, articles, devices, or any surface of interest are contemplated. The methods involve providing a label assembly that includes an axially oriented substrate which includes impact copolymer polypropylene (ICP) and a layer of an adhesive. The methods also involve contacting the adhesive with the container or item of interest to thereby adhere or secure the substrate to the container or item of interest. Preferably, the adhesive is a pressure sensitive adhesive. However, the subject matter includes the use of other types of adhesive. For example, the various embodiments described herein can be used in conjunction with nearly any type of acrylic-based emulsion adhesives. The preferred embodiment methods may also optionally include one or more heating operations. Applying heat to the oriented films will result in shrinkage of the film(s). Heat may be applied prior to, during, or after application of the label substrate to the container or item of interest. One or more optional printing operations may also be employed using ultraviolet (UV) inks, UV flexo inks, solvent-based inks, and water-based inks.

Also provided are techniques for selectively adjusting the die cut resistance and/or conformability of a polymeric layer and particularly of such a layer comprising ICP, by selective orientation of the material in a machine direction. For example, die cutting resistance of a film can be reduced by using a particular extent of machine direction orientation. In addition, conformability of a film can be reduced by use of a particular extent of machine direction orientation.

### EXAMPLES

A series of trials were conducted to evaluate various properties and characteristics of several preferred embodiment film assemblies. Specifically, characteristics related to “ticker” strength (i.e., die cut friction energy), haze, clarity, gloss, stiffness or bending resistance, elastic modulus, and density were evaluated.

Tables 1A and 1B summarize various film constructions designated as samples A-E. Generally, each sample included on outer “print” layer, an inner “core” layer, and an adhesive layer. In all samples, the inner core layer constituted the majority weight and thickness proportion of the samples. Samples included various amounts of ICP in the core layer, and optionally in the print layer and in the adhesive layer. A control sample having a similar structure included a core layer free of ICP.

TABLE 1A
Samples A, B, and C

| | Sample | | | | | | | | |
|---|---|---|---|---|---|---|---|---|---|
| | A | | | B | | | C | | |
| | Print | Core | Adhesive | Print | Core | Adhesive | Print | Core | Adhesive |
| Layer % | 5.0% | 90.0% | 5.0% | 5.0% | 90.0% | 5.0% | 5.0% | 90.0% | 5.0% |
| AB | 3.0% | | 1.0% | 10.0% | | 5.0% | 10.0% | | 10.0% |
| AO | | | | | | | | | |
| EVA (18%) | | | 25.05% | | | | | | |
| HPP | | | | 23.0% | 60.0% | 70.0% | | | |
| ICP | 48.5% | 100.0% | 74.0% | | 40.0% | | | 20.0% | |
| LLDPE | | | | 42.0% | | 10.0% | 80.0% | | 80.0% |
| mPE | | | | 25.0% | | 15.0% | | | |
| RCP | | | | | | | | 80.0% | |
| Zn Ion | 48.5% | | | | | | | | |
| a-PE/PP | | | | | | | 10.0% | | 10.0% |

| | | | |
|---|---|---|---|
| MDO Ratio | 5.50:1 | 5.30:1 | 5.00:1 |

TABLE 1B
Samples D and E

| | Sample | | | | | |
|---|---|---|---|---|---|---|
| | D | | | E | | |
| | Print | Core | Adhesive | Print | Core | Adhesive |
| Layer % | 5.0% | 90.0% | 5.0% | 7.6% | 84.8% | 7.6% |
| AB | 10.0% | | 7.0% | 10.0% | | 7.0% |
| AO | 2.0% | | | | | |
| EVA | | | | | | |
| (18%) | | | | | | |
| HPP | 24.0% | 15.0% | 70.0% | 23.0% | 60.0% | 70.0% |
| ICP | | | | | 40.0% | |
| LLDPE | 40.0% | | 9.0% | 42.0% | | 9.0% |
| mPE | 24.0% | 15.0% | 14.0% | 25.0% | | 14.0% |
| RCP | | 70.0% | | | | |
| Zn Ion | | | | | | |
| a-PE/PP | | | | | | |

| | | |
|---|---|---|
| MDO | 5.30:1 | 5.30:1 |
| Ratio | | |

Table 2 summarizes and describes each of samples A-E.

TABLE 2
Samples A-E

| Sample | Description |
|---|---|
| A | ICP Skins/Core |
| B | HPP/ICP Core |
| C | PE-Skins + RCP/ICP Core |
| D | Control |
| E | HPP/ICP Core |

Table 3 is a listing of various materials used in the samples of Tables 1A, 1B, and 2. These are the generic names for the materials used in the trials.

TABLE 3
Materials in Samples

| Code | Description |
|---|---|
| AB | Anti-Block |
| AO | Anti-Oxidant |
| EVA | Ethylene Vinyl Acetate |
| HPP | Homopolymer Polypropylene |
| ICP | Impact Copolymer Polypropylene |
| LLDPE | Linear Low Density Polyethylene |
| mPE | Metallocene-catalyzed Linear Low Density Polyethylene |
| RCP | Random Copolymer Polypropylene |
| Zn Ion | Zinc Ionomer |
| a-PE/PP | Alpha-Olefin Ethylene/Propylene Copolymer |

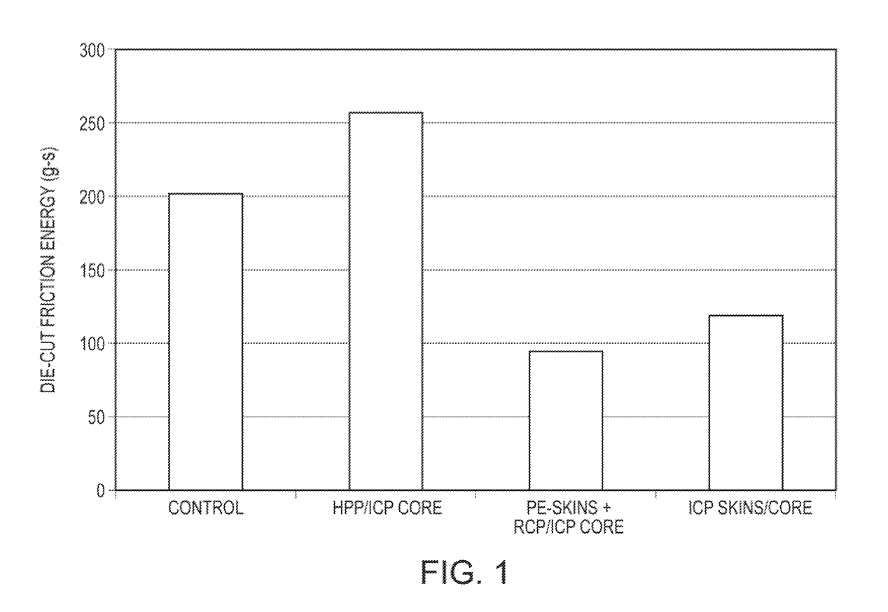

FIG. 1 illustrates die cut friction energy determinations for samples B and E (HPP/ICP core), C (PE-skins+RCP/ICP core), and A (ICP skins/core), compared to a control sample D. Generally, it is desired that die cut friction energy be low. Accordingly, samples A and C exhibited improved die cut properties as compared to the control sample and samples B and E. Samples B and E exhibited higher die cut friction energy than the control sample.

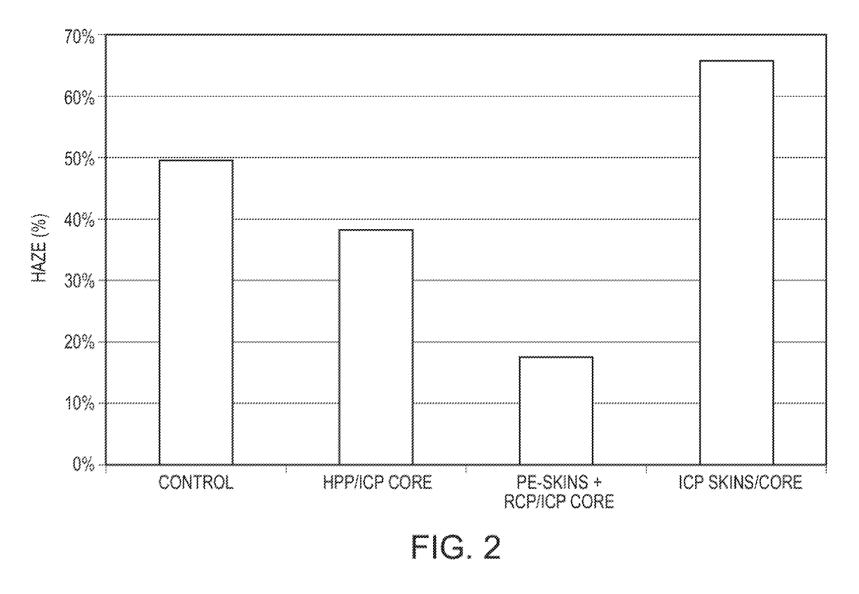

FIG. 2 illustrates natural film haze measurements of the samples. As will be appreciated, the haze will generally decrease upon application of an adhesive and over-varnish. Samples B, E, and C exhibited less haze than the control sample, while sample A exhibited greater haze than the control.

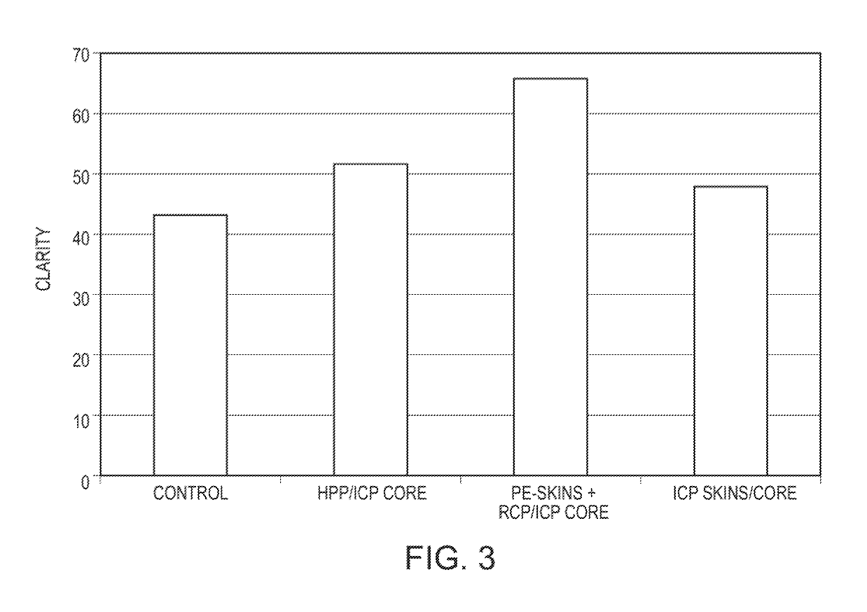

FIG. 3 illustrates clarity of the various samples. All samples A, B, C, and E exhibited improved clarity as compared to the control sample.

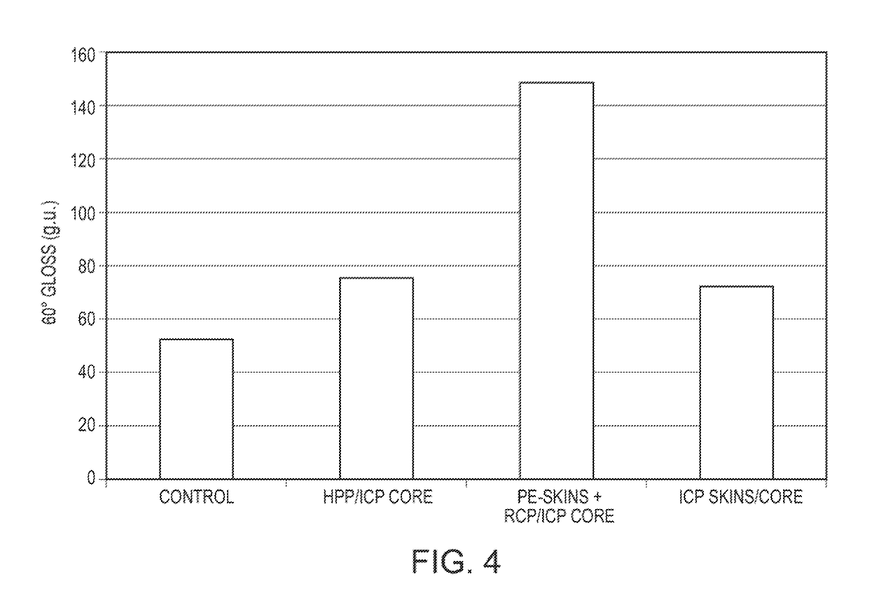

FIG. 4 illustrates 60° gloss values for the various samples. All samples A, B, C, and E exhibited higher gloss values as compared to the control sample. Typically, higher gloss values are desirable for top coats and metallic ink applications.

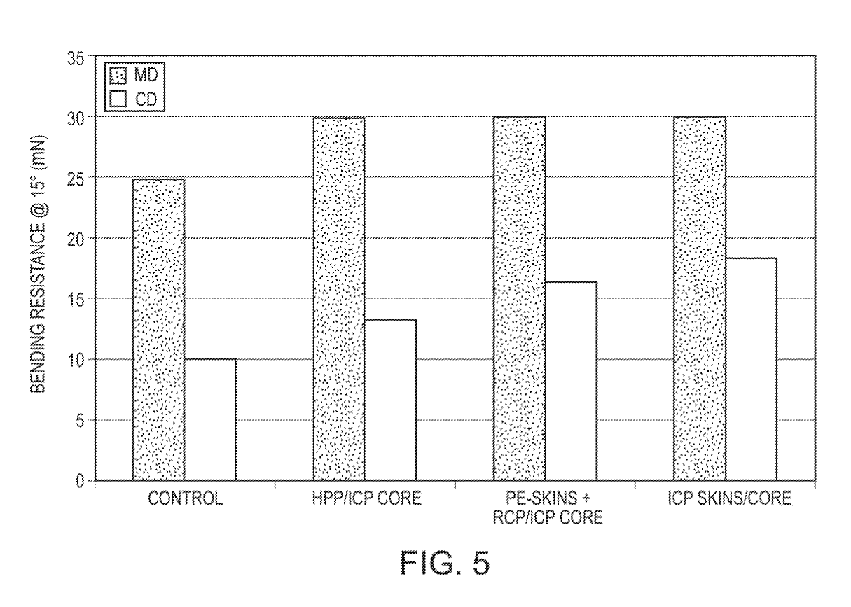

FIG. 5 illustrates stiffness or bending resistance in a machine direction (MD) and a cross direction (CD) for the samples and control. All samples exhibited greater stiffness in both the machine direction and in the cross direction as compared to the control sample. Typically, higher stiffness is preferred for dispensing operations.

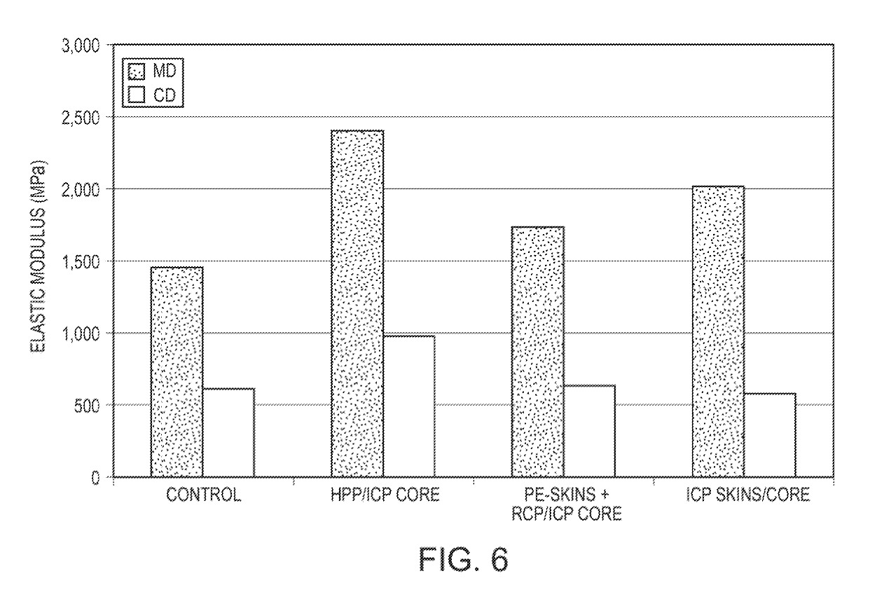

FIG. 6 illustrates various elastic modulus values in both the machine direction (MD) and the cross direction (CD) for the samples as compared to the control sample. As will be understood, elastic modulus is a measure of resistance to deformation. All samples A, B, C and E exhibited greater modulus in the machine direction, as compared to the control sample. And, all samples exhibited greater or substantially the same modulus values in the cross direction as compared to the control sample. Typically, high elastic modulus values are preferred for printing. And typically, low modulus values indicate good conformability to a non-planar substrate such as a bottle.

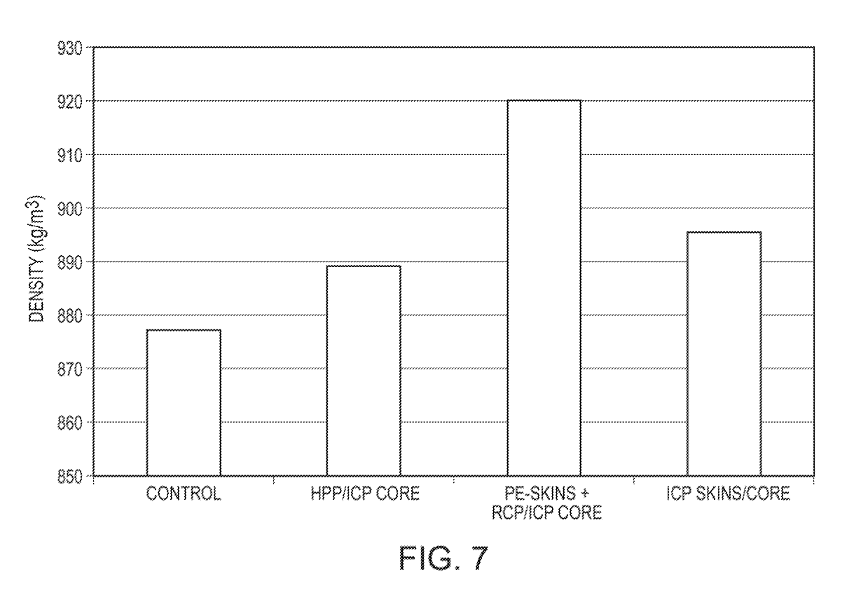

FIG. 7 illustrates densities of the samples compared to the control. All samples exhibited greater densities than the sample.

The previously noted results and data surprisingly demonstrate that the incorporation of ICP in a substrate, for example in one or both of a print layer and/or a core layer, does not significantly affect clarity, improved die cutting, and appears to suppress the minimum amount of energy (i.e. temperature and stress) required to orient more crystalline polymers. Examples of more crystalline polymers include homopolymer polypropylene (HPP) and random copolymer polypropylene (RCP). Providing an oriented PE surface without significant defects is believed to provide a significant advance in the art.

Another series of trials were conducted to evaluate film samples formed from single and multiple component blends of random copolymer polypropylene (RCP) and impact copolymer polypropylene (ICP). Specifically, samples were prepared from 100% RCP, a blend of 75% RCP and 25% ICP, 50% RCP and 50% ICP, 25% RCP and 75% ICP, and 100% ICP. The various samples were compared to controls of commercially available materials of PE-85 available from Charter Films of Superior, Wis., and TC-BOPP available from ExxonMobil Chemical. Table 4 summarizes and describes each of the various samples.

TABLE 4
Samples F-L

| Sample | Description |
|---|---|
| F | 100% RCP |
| G | 75% RCP and 25% ICP |
| H | 50% RCP and 50% ICP |
| I | 25% RCP and 75% ICP |
| J | 100% ICP |
| K | PE-85 Control |
| L | BOPP Control |

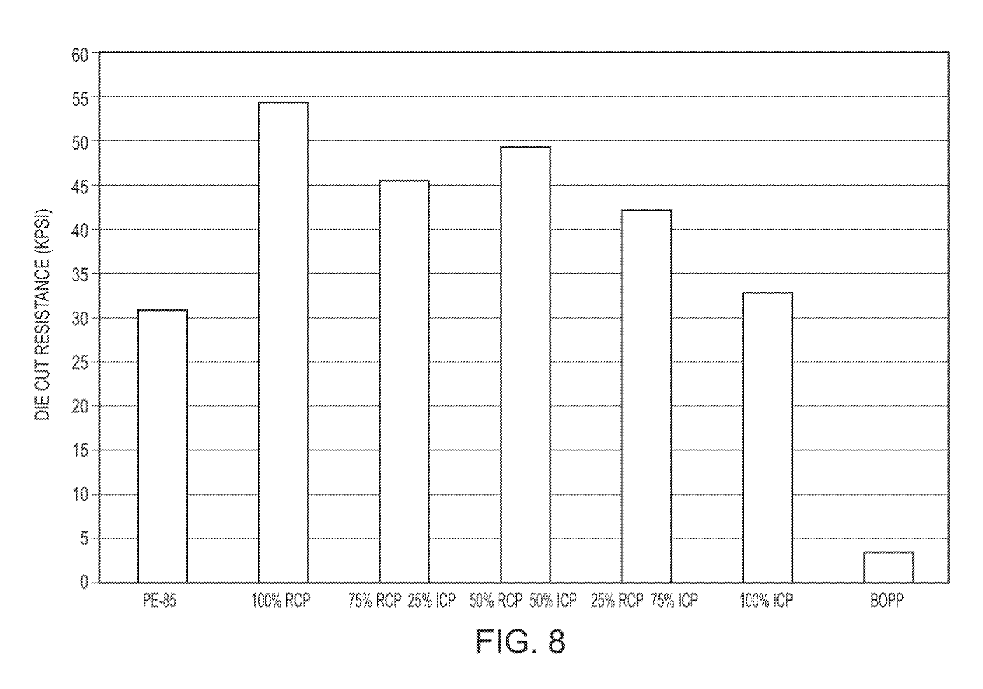

FIG. 8 illustrates calculated die cut performance of machine-direction (MD) oriented ICP blends with RCP. It is generally desirable to reduce die cut resistance. Thus, as demonstrated in the data of FIG. 8, die cut resistance of RCP materials can be reduced by incorporating amounts of ICP in the blend of RCP and ICP.

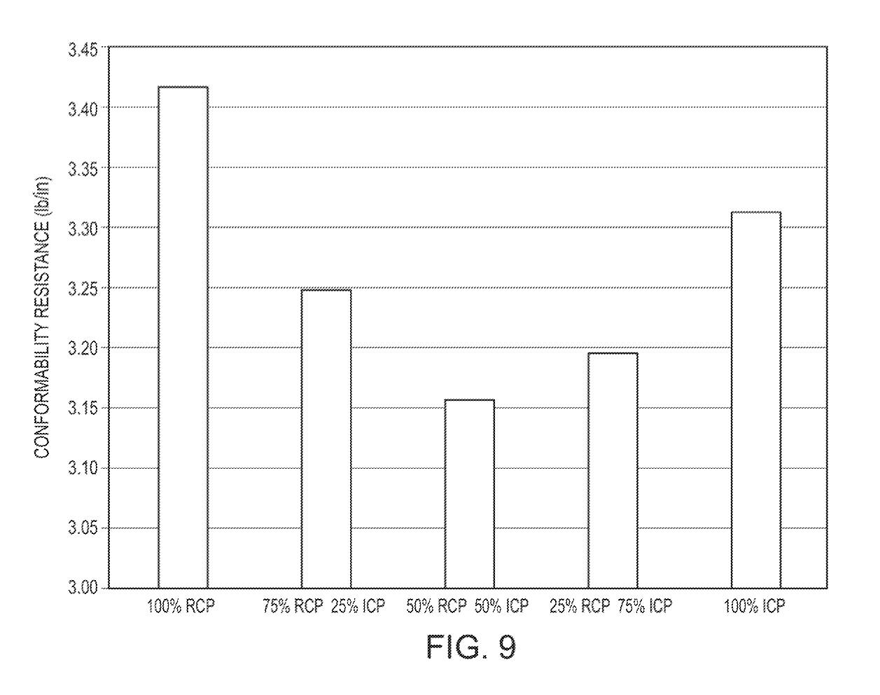

FIG. 9 illustrates calculated conformability of machine direction oriented ICP blends with RCP. It is typically preferred to reduce conformability resistance. As evident in FIG. 9, conformability resistance of RCP materials can be reduced by incorporating amounts of ICP therein.

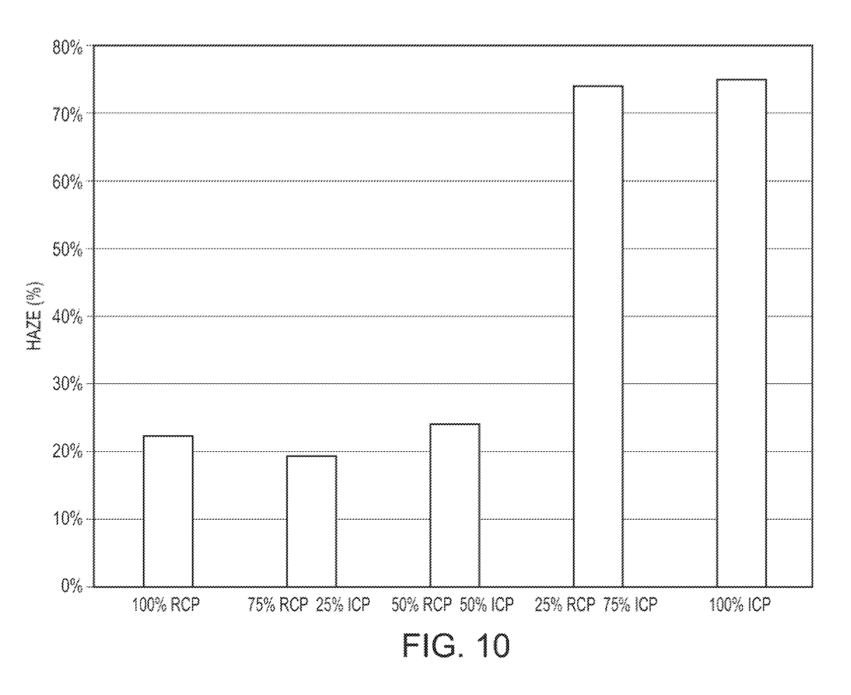

FIG. 10 illustrates measured haze of machine direction oriented ICP blends with RCP. Typically, it is desirable to provide films with a low haze percentage. As shown in FIG. 10, relatively large proportions of ICP such as up to about 50%, can be used in a blend of RCP and ICP without significantly increasing the haze of the resulting blend.

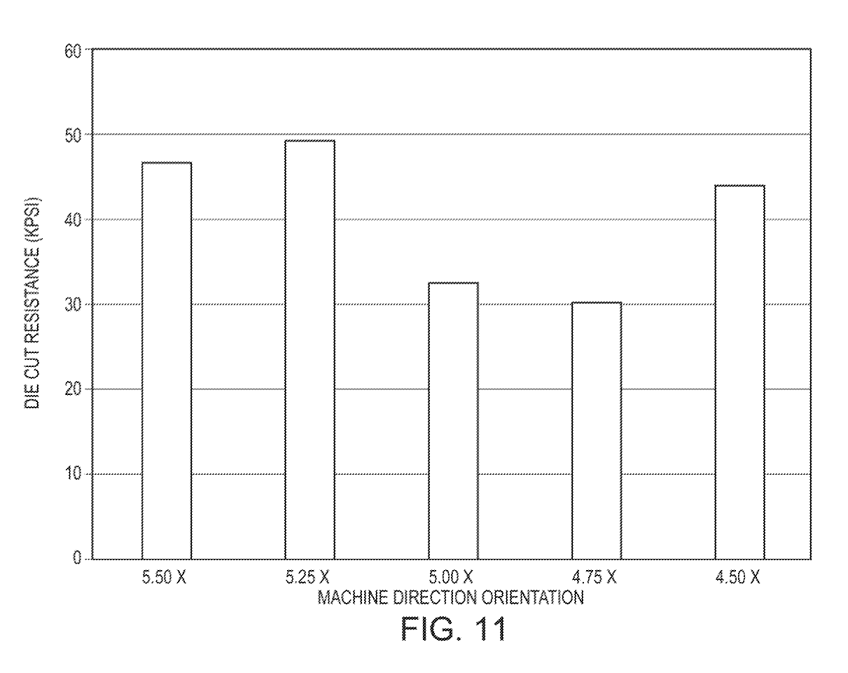

FIG. 11 illustrates calculated effect of increasing machine direction orientation on die cutting. For many applications, it is preferred that die cut resistance be relatively low. And so, it can be seen that an orientation in the machine direction of from about 4.50X to about 5.25X provides a reduced die cut resistance as compared to corresponding samples however such samples being at orientations of 5.25X or greater, or orientations of 4.50X or less.

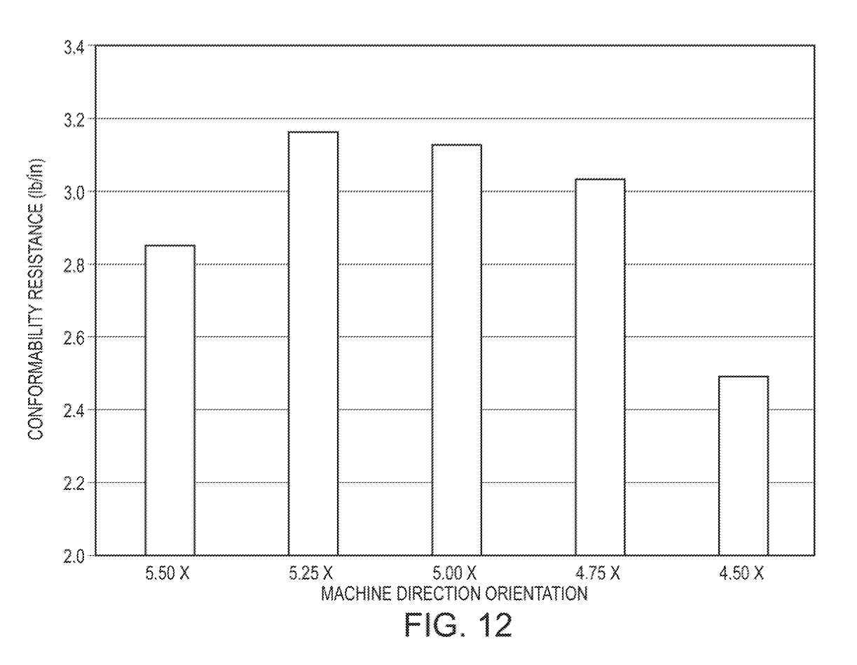

FIG. 12 illustrates calculated effect of increasing machine direction orientation on conformability. Typically, it is desirable that conformability resistance be relatively low. As evident in FIG. 12, conformabilities can be obtained at orientations less than about 5.00X.

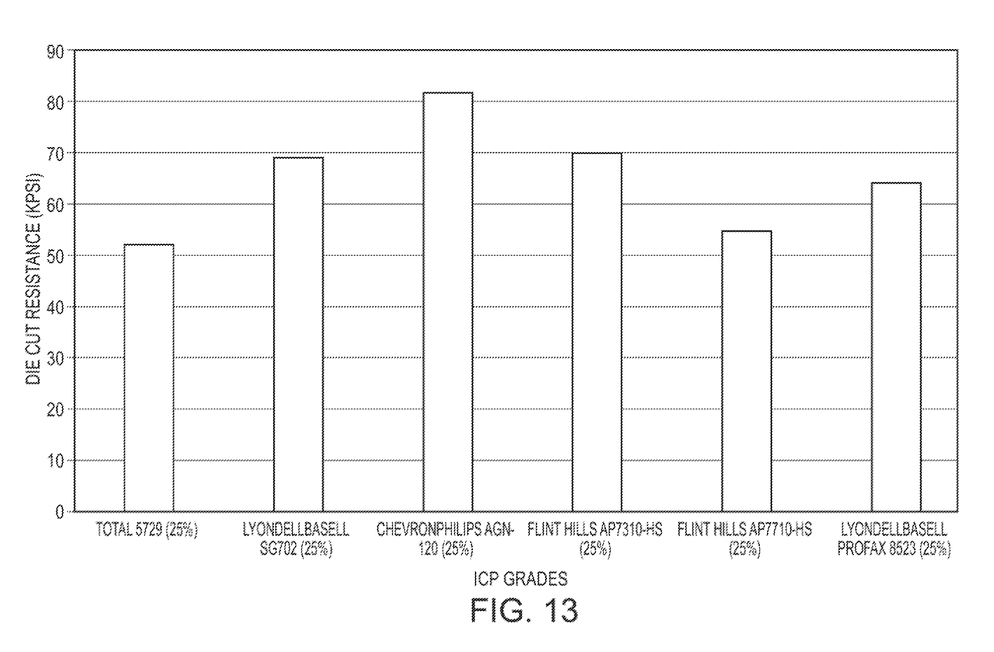

FIG. 13 illustrates calculated die cutting resistance of different machine direction oriented ICP grades blended with RCP. The various ICP materials were all commercially available ICP resins available under the following designations: (i) TOTAL 5759, (ii) LyondellBasell SG702, (iii) ChevronPhillips AGN-120, (iv) Flint Hills AP 7310-HS, (v) Flint Hills AP 7710-HS, and (vi) LyondellBasell Profax 8523. Each ICP grade was blended with 25% of RCP.

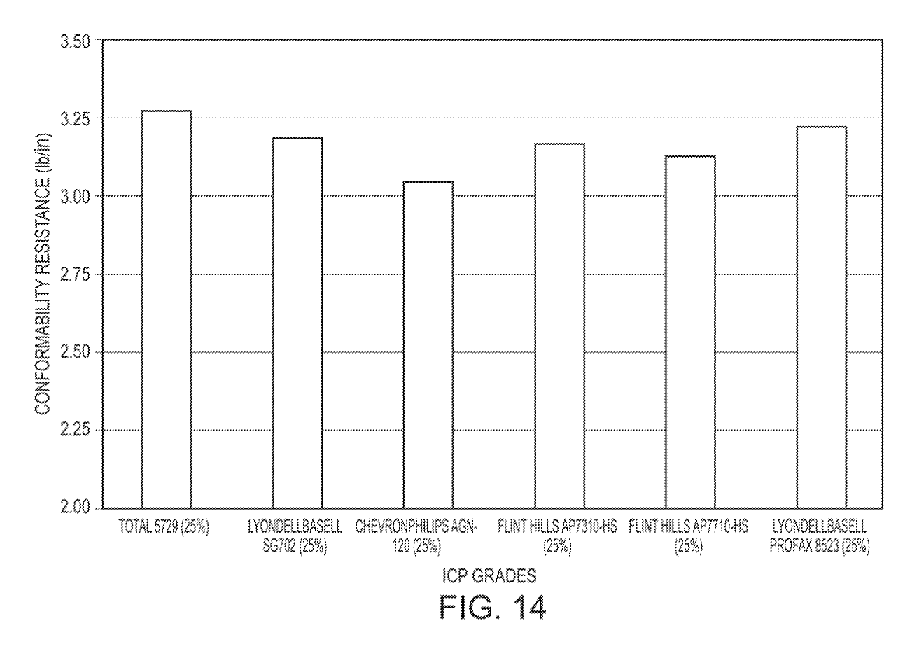

FIG. 14 illustrates calculated conformability of different machine direction ICP grades blended with RCP. The same commercially available ICP grades as described in association with FIG. 13, were blended with 25% RCP.

Comparing FIGS. 13 and 14, it is evident that blends of ICP and RCP for improving, i.e. reducing, die cut resistance; and for improving, i.e. reducing, conformability resistance, are generally in opposition to each other.

Many other benefits will no doubt become apparent from future application and development of this technology.

All patents, applications, and articles noted herein are hereby incorporated by reference in their entirety.

As described hereinabove, the present subject matter solves many problems associated with previous films and/or labels. However, it will be appreciated that various changes in the details, materials, and arrangements of components, which have been herein described and illustrated in order to explain the nature of the subject matter, may be made by those skilled in the art without departing from the principle and scope of the subject matter, as expressed in the appended claims.

What is claimed is:

1. An axially oriented label facestock comprising a blend of an impact copolymer polypropylene (ICP) and at least one other polymeric material.

2. The label facestock of claim 1, wherein the at least one other polymeric material is selected from the group consisting of homopolymer polypropylene (HPP), random copolymer polypropylene (RCP), and combinations thereof.

3. The label facestock of claim 1, wherein the ICP is one of high impact, medium impact, and low impact as determined by ASTM D256.

4. The label facestock of claim 1, wherein the ICP is one of high impact, medium impact, and low impact as determined by extraction of a rubbery component.

5. The label facestock of claim 1, wherein the ICP is one of high impact, medium impact, and low impact as determined by ethylene content added to a polymerization reactor.

6. The label facestock of claim 1, wherein the label facestock includes a print layer and a core layer, at least one of the print layer and the core layer including the ICP.

7. The label facestock of claim 6, wherein the print layer includes the ICP.

8. The label facestock of claim 7, wherein the print layer further includes at least one polymer selected from the group consisting of polyethylenes, polypropylenes, other polyolefins, (meth)acrylates, ethylene vinyl acetate copolymers, ionomers, and combinations thereof.

9. The label facestock of claim 7, wherein the print layer further includes at least one additive selected from the group consisting of nucleating agents, antioxidants, processing aids, and combinations thereof.

10. The label facestock of claim 6, wherein the core layer includes the ICP.

11. The label facestock of claim 10, wherein the core layer further includes at least one polymer selected from the group consisting of polyethylenes, polypropylenes, other polyolefins, (meth)acrylates, ethylene vinyl acetate copolymers, ionomers, and combinations thereof.

12. The label facestock of claim 10, wherein the core layer further includes at least one additive selected from the group consisting of nucleating agents, antioxidants, processing aids, and combinations thereof.

13. The label facestock of claim 1, wherein the facestock is monaxially oriented.

14. The label facestock of claim 1, wherein the facestock is biaxially oriented.

15. The label facestock of claim 1, wherein the facestock comprises ICP and HPP.

16. The label facestock of claim 1, wherein the facestock comprises ICP and RCP.

17. A label assembly comprising:
an axially oriented substrate including a blend of an impact copolymer polypropylene (ICP) and at least one other polymeric material; and
a layer of an adhesive.

18. The label assembly of claim 17, wherein the at least one other polymeric material is selected from the group consisting of homopolymer polypropylene (HPP), random copolymer polypropylene (RCP), and combinations thereof.

19. The label assembly of claim 17, wherein the ICP is one of high impact, medium impact, and low impact as determined by ASTM D256.

20. The label assembly of claim 17, wherein the ICP is one of high impact, medium impact, and low impact as determined by extraction of a rubbery component.

21. The label assembly of claim 17, wherein the ICP is one of high impact, medium impact, and low impact as determined by ethylene content added to a polymerization reactor.

22. The label assembly of claim 17, wherein the substrate includes a print layer and a core layer, at least one of the print layer and the core layer including the ICP.

23. The label assembly of claim 22, wherein the print layer includes the ICP.

24. The label assembly of claim 23, wherein the print layer further includes at least one polymer selected from the group consisting of polyethylenes, polypropylenes, other polyolefins, (meth)acrylates, ethylene vinyl acetate copolymers, ionomers, and combinations thereof.

25. The label assembly of claim 23, wherein the print layer further includes at least one additive selected from the group consisting of nucleating agents, antioxidants, processing aids, and combinations thereof.

26. The label assembly of claim 22, wherein the core layer includes the ICP.

27. The label assembly of claim 26, wherein the core layer further includes at least one polymer selected from the group consisting of polyethylenes, polypropylenes, other polyolefins, (meth)acrylates, ethylene vinyl acetate copolymers, ionomers, and combinations thereof.

28. The label assembly of claim 26, wherein the core layer further includes at least one additive selected from the group consisting of nucleating agents, antioxidants, processing aids, and combinations thereof.

29. The label assembly of claim 17, wherein the substrate is monoaxially oriented.

30. The label assembly of claim 17, wherein the substrate is biaxially oriented.

31. The label assembly of claim 18, wherein the substrate comprises ICP and HPP.

32. The label assembly of claim 18, wherein the substrate comprises ICP and RCP.

33. A method of labeling a container, the method comprising:
providing a label assembly including (i) an axially oriented substrate comprising a blend of an impact copolymer polypropylene (ICP) and at least one other polymeric material and (ii) a layer of an adhesive; and
contacting the layer of the adhesive of the label assembly with the container.

34. The method of claim 33, wherein the at least one other polymeric material is selected from the group consisting of homopolymer polypropylene (HPP), random copolymer polypropylene (RCP), and combinations thereof.

35. The method of claim 33, wherein the adhesive is a pressure sensitive adhesive.

36. The method of claim 33, further comprising:
heating the label assembly to thereby induce shrinkage of the axially oriented substrate.
